(19) United States
(12) Patent Application Publication
(10) Pub. No.: US 2006/0109084 A1
(43) Pub. Date: May 25, 2006

(54) Mesh networking with RFID communications

(76) Inventor: Mark Yarvis, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/997,596

(22) Filed: Nov. 24, 2004

(51) Int. Cl. H04Q 5/22

(52) U.S. Cl. 340/10.1; 340/10.2

(57) ABSTRACT

A network of devices that use radio frequency identification (RFID) technology for communications may establish an ad hoc configuration for the network by identifying which RFID tags are shared by which RFID readers, and by creating and maintaining a distributed database of those configurations to facilitate the routing of communications between any tow nodes in the network.

### BACKGROUND

‘Mote’ is a common term used to describe battery-powered sensor devices that communicate their collected data by wireless radio transmissions. Such sensor devices may be used to monitor various things such as temperature, humidity, vibration, light levels, sound levels, etc. In many instances, the motes are designed to set up ad hoc wireless mesh networks with each other, so that each mote's data may be delivered to a central data collector by passing the information through multiple other motes until it reaches the desired destination. However, since transmitting can drain a battery quickly, and just keeping the circuitry active to be ready to receive a transmission can also use significant battery power, keeping the network operating may significantly shorten battery life in all the motes. To increase battery life, each mote may be periodically put into a low-power ‘sleep’ mode, but the sleep modes need to be coordinated. Without such coordination, various motes may be asleep when they are needed, and/or may waste battery power by waking up and monitoring for traffic when they aren't needed. Extending the effective battery life of motes is a major challenge.

### BRIEF DESCRIPTION OF THE DRAWINGS

The invention may be understood by referring to the following description and accompanying drawings that are used to illustrate embodiments of the invention. In the drawings:

FIG. 1 shows a block diagram of a device using RFID technology for communications, according to an embodiment of the invention.

FIG. 2 shows a network using RFID tags as transfer nodes, according to an embodiment of the invention.

FIGS. 3A and 3B show tables that may be used for network routing, according to an embodiment of the invention.

FIG. 4 shows a flow diagram of a method of determining where to forward a message, according to an embodiment of the invention.

FIG. 5 shows a flow diagram of a method of handling a message within an RFID tag, according to an embodiment of the invention.

FIG. 6 shows a flow diagram of a method of creating a neighbor list, according to an embodiment of the invention.

FIG. 7 shows a flow diagram of a method of creating a routing list, according to an embodiment of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, the different embodiments described my have some, all, or none of the features described for other embodiments.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Various embodiments of the invention may be implemented in one or a combination of hardware, firmware, and software. The invention may also be implemented as instructions stored on a machine-readable medium, which may be read and executed by a computing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces and/or antennas that transmit and/or receive those signals, etc.), and others.

Various embodiments of the invention may use radio frequency identification (RFID) tags on devices as data forwarding nodes in a network of devices. By using RFID technology for the communications operation, a mesh network may be set up that operates without consuming any on-board power in the devices, thus removing battery drain as a significant limitation on the use of such devices. In some embodiments, this may greatly extend the life of battery-powered motes that form a network, although other embodiments may use the same techniques with devices other than motes.

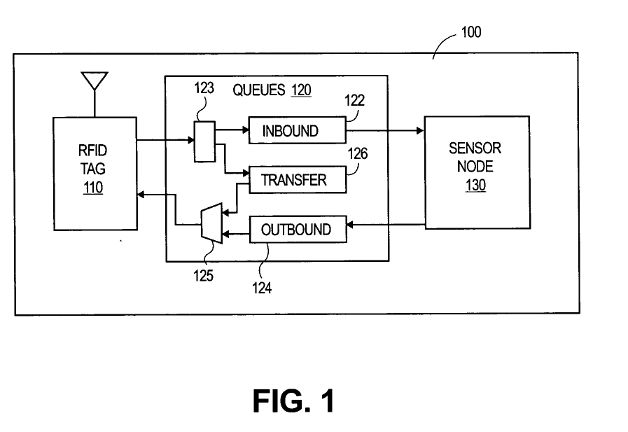

FIG. 1 shows a block diagram of a device using RFID technology for communications, according to an embodiment of the invention. The illustrated embodiment shows a device 100 that includes three main components: a sensor node 130 for sensing and/or measurement operations, an RFID tag 110 for communications into and out of the device 100, and a set of queues 120 to hold data while it is being transferred between the RFID tag 110 and the sensor node 130. Sensor node 130 may comprise a battery to power its operations, and may further have a low-power mode to conserve battery power during intervals when the sensor node is not operating. Since the communications may be handled by the RFID tag without the need for battery power, communications may take place regardless of whether the sensor node 130 is in a low-power mode Although the illustrated embodiments and associated text describe devices that contain a ‘sensor’ node (i.e., a node that takes sensor readings such as temperature, light level, moisture, etc.), other embodiments may have circuitry to perform operations other than sensing, while still retaining the RFID tag and the queues.

Within the context of this disclosure, an RFID tag may be an electronic circuit adapted to receive incoming radio frequency energy through its antenna, use a portion of that energy to power its own circuitry, and operate that circuitry to modulate a radio frequency signal to transmit data out through the antenna. (Note: although some technical literature refers to an RFID tag ‘reflecting’ a modulated signal rather than ‘transmitting’ the signal, in this document the term ‘transmit’ and its derivatives will be used consistently to encompass both terms.) RFID tag 110 may also contain circuitry to perform additional operations. In some embodiments the transmitted data comprises an identification code that identifies the RFID tag that is responding, and by association, may identify the device 100. The RFID tag may use any feasible RFID technology currently existing or yet to be developed that uses the incoming electromagnetic energy as a power source for the RFID circuitry. In some embodiments, the RFID tag 110 may be able to read data from outbound queue 124 and transmit that data as a part of a transmission from the antenna. In some embodiments, the RFID tag may be able to receive data that has been received through its antenna, and write that data into inbound queue 122.

Inbound queue 122 and outbound queue 124 may be used as temporary storage for data that is being passed between RFID tag 110 and sensor node 130, but other embodiments may use other arrangements. Some embodiments that transfer data in only one direction between RFID tag 110 and sensor node 130 may use only an inbound queue or only an outbound queue, but not both. The queues 120 may be physically implemented in any feasible manner, such as but not limited to shift register buffers, addressable memory, etc. In some embodiments the queues may comprises non-volatile logic that maintains its state when electrical power is removed. In some embodiments the queues may be implemented with non-volatile low power logic that can be operated with only the power received by the RFID tag 110 through its antenna, but other embodiments may use other techniques, such as using volatile logic powered by the battery in the sensor node.

Queues 120 may also comprise a transfer queue 126. When data is received through the RFID tag 110, that data may be written into transfer queue 126 rather than being written into inbound queue 122 for access by the sensor node 130. Selector 123 may be used to direct inbound data to either the inbound queue 122 or the transfer queue 126. Once data is placed in transfer queue 126, that data may be subsequently read from the transfer queue and transmitted by RFID tag 110. Multiplexer 125 may select whether the transmitted data is from transfer queue 126 or outbound queue 124. RFID tag 110 may have the capability to read and write transfer queue 126 using only the power collected by RFID tag 110 when it receives electromagnetic radiation through its antenna.

By using the transfer queue 126, device 100 may act as a store-and-forward node for data originated by a first device and destined for a second device, when the first and second devices don't communicate directly with each other. Device 100 may perform this operation without using any battery power, by using the energy of received signals to power the RFID tag 110, transfer queue 126, and associated circuitry.

In some embodiments, the electromagnetic radiation received through the antenna may be in the form of a modulated radio frequency (RF) carrier wave encoded with data, a destination address for that data (e.g., a final destination that the data is to reach), and a recipient address (e.g., which device is to receive this transmission). The RFID tag may have sufficient processing capability to decode the destination address, decode the recipient address, and write the data to either inbound queue 122 or transfer queue 126 (or ignore the data when appropriate).

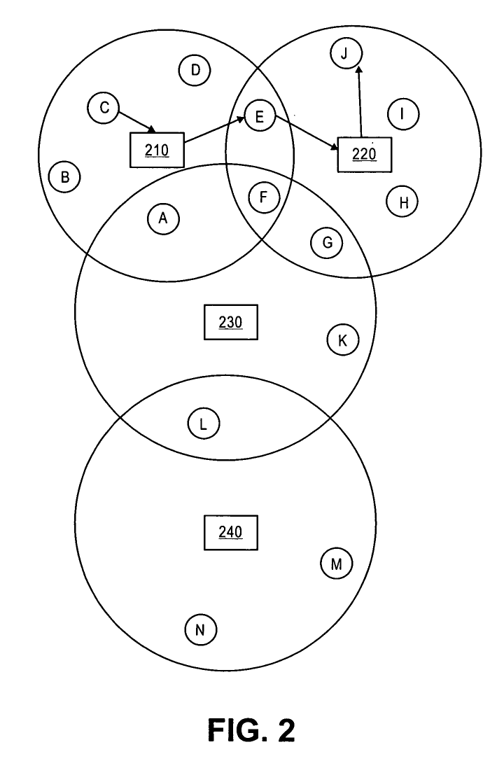

FIG. 2 shows a network using RFID tags as transfer nodes, according to an embodiment of the invention. RFID readers 210, 220, 230 and 240 may be devices that can communicate with RFID tags within their range by transmitting electromagnetic energy on a proper frequency so that the RFID tags will collect that electromagnetic energy, use that energy to power their own circuitry, and transmit a response if appropriate. Since RFID tags need to receive a transmission from an RFID reader before the RFID tags can operate, the RFID tags may not communicate directly with each other, but may communicate with an RFID reader.

The following description refers to RFID tags and RFID readers. It should be understood that any of the RFID tags and any of the RFID reader may be attached to one or more other electronic devices that may be necessary for the described operations to work. In the illustrated embodiment, each RFID reader is shown at the center of a circle that represents the tag-to-reader communication range of that RFID reader. In the illustrated configuration, RFID reader 210 may communicate directly with RFID tags A, B, C, D, E, F, RFID reader 220 may communicate directly with RFID tags E, F, G, H, I, J, RFID reader 230 may communicate directly with RFID tags A, F, G, K, L, and RFID reader 240 may communicate directly with RFID tags L, M, N. As an example of how this network may be used, if RFID tag C is to communicate a message to RFID tag A, then RFID tag C may transmit the message from its outbound queue when polled by RFID reader 210, and subsequently RFID tag A may receive the message from RFID reader 210 and place the message into its inbound queue when RFID tag A is polled by RFID reader 210. RFID readers are known, and the internal workings of the RFID readers are therefore not described here to avoid distracting from the descriptions of the embodiments of the invention. (Note: The term ‘message’, as used herein, may comprise any communication of data that is intended to be conveyed between nodes in a network, regardless of content or structure, and may be modified as needed within the various devices as the message passes along its communication path. The message may be formatted in any feasible manner, such as but not limited to one or more packets.)

If, however, RFID tag C is to send a message to RFID tag J, the two-stage operation just described may not work: RFID tag J is out of range of RFID reader 210, while RFID tag C is out of range of RFID reader 220. Further, RFID readers may generally not be configured to communicate directly with each other. However, RFID tags E and F are within range of both RFID readers 210 and 220, and either may therefore be used as a store-and-forward node. RFID tag E was selected in the illustrated data path from C to 210 to E to 220 to J.

To complete this overall communication, RFID tag C may read data from its outbound queue and transmit that data to RFID reader 210 when polled by RFID reader 210. RFID reader 210 may then poll RFID tag E and transmit the data to RFID tag E during that poll. RFID tag E may write the data into its transfer queue. RFID tag E may read the data from its transfer queue and transmit that data to RFID reader 220 when polled by RFID reader 220. RFID reader 220 may then poll RFID tag J and transmit the data to RFID tag J during that poll. RFID tag J may write the data into its inbound queue, to be used by the device connected to RFID tag J. In this manner, devices that use RFID tags for communications may exchange data with each other without using their own battery power, even though they may be far apart. Although the example just described only uses two RFID readers, other examples may use a larger number of RFID readers. For example, a communication from RFID tag C to RFID tag N might travel from C to 210 to F to 230 to L to 240 to N. As long as RFID tags are located in the overlapping operating ranges of the necessary readers, a path may be found between any two RFID tags in the network. FIG. 2 shows four RFID readers in the network, but other configurations may use other quantities of RFID readers.

For the previously-described routing mechanism to work properly, a route between the origination and destination nodes needs to be determined. Although a totally random ad hoc mechanism could theoretically be used for every communication, a more structured route may be more efficient. One or more tables may be used to determine the preferred routes.

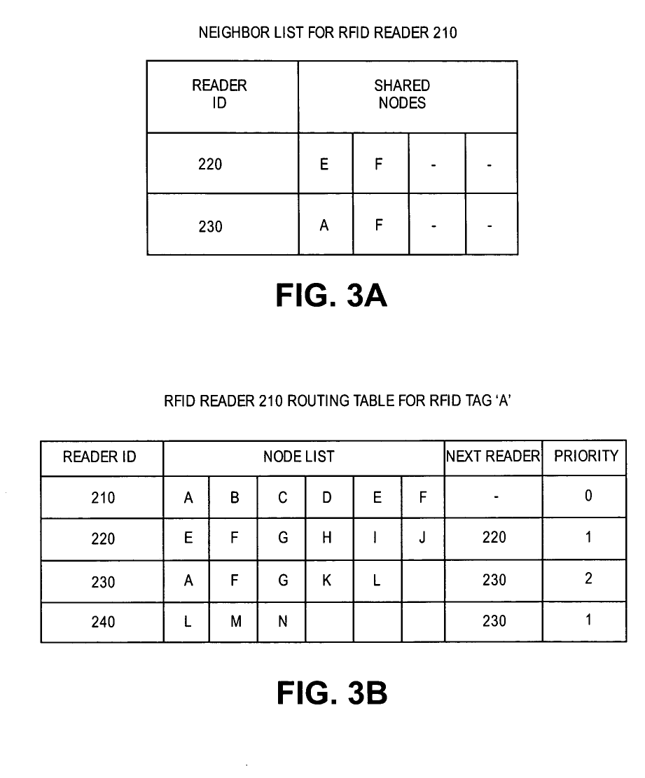

FIGS. 3A and 3B show tables that may be used for network routing, according to an embodiment of the invention. FIG. 3A shows an example of a neighbor list, which each RFID reader may maintain to show the adjacent RFID readers (i.e., other RFID readers that can be reached through a single RFID tag). The illustrated neighbor list may be stored in RFID reader 210 of FIG. 2. It shows that RFID reader 220 has RFID tags E and F in common with RFID reader 210, so a communication between RFID readers 210 and 220 can be directed through either of those two RFID tags, without requiring the use of other RFID tags or other RFID readers. Similarly, RFID reader 230 has RFID tags A and F in common with RFID reader 210. There are no other adjacent readers in this example. If RFID reader 210 wishes to get a message to a reader or tag not shown in this list, it may do so indirectly by first sending the message to one of these adjacent readers through one of the indicated tags. Although the example lists only two adjacent readers and only two shared nodes per reader, the neighbor list may contain as many adjacent readers and as many shared nodes for each reader as are feasible. Which of the available adjacent readers is selected may be indicated by a routing table.

FIG. 3B shows a routing table, according to an embodiment of the invention. A routing table may be maintained for each RFID tag. In some embodiments, the routing tables are maintained in each RFID reader for all RFID readers and all RFID tags in the network, or at least represents a reasonable attempt to include all RFID tags. The example shown in FIG. 3B is a routing table stored in RFID reader 210, for RFID tag A. In the illustrated embodiment of FIG. 3B, which reflects the network configuration of FIG. 2, each RFID reader in the network is listed, with a list of nodes (RFID tags) that are able to be reached directly by that RFID reader. The example routing table of FIG. 3B shows four RFID readers and up to 6 RFID tags per reader, but the table may be sized for any feasible number of readers and tags per reader.

When the RFID reader is to send a message to a particular node, it may scan the node lists in the routing table for that particular node. When it finds an RFID reader that services that particular node, it may look in the ‘next reader’ column to determine which adjacent reader to send the message to. If the indicated node is shown for more than one RFID reader, either reader may be chosen to send the message to. However, the reader with the lowest priority number may be chosen as a preferred selection. The priority may represent a metric that is based on any relevant properties, such as but not limited to path length, quality, etc. After choosing a next reader, the RFID reader may then look at its own neighbor list to determine which RFID tags are available to communicate with that particular RFID reader, and choose one of those RFID tags as a store-and-forward node for the communication with the selected adjacent reader. If more than one RFID tag is available, any feasible method may be used to select one.

In some embodiments, each RFID reader in the network may have one neighbor list, and a separate routing table for each local RFID tag (‘local’ meaning that the RFID reader is able to communicate directly with that tag rather than communicating indirectly through another RFID reader). The RFID reader may use the routing table for the RFID tag from which it receives the message, whether or not the message originated with that RFID tag.

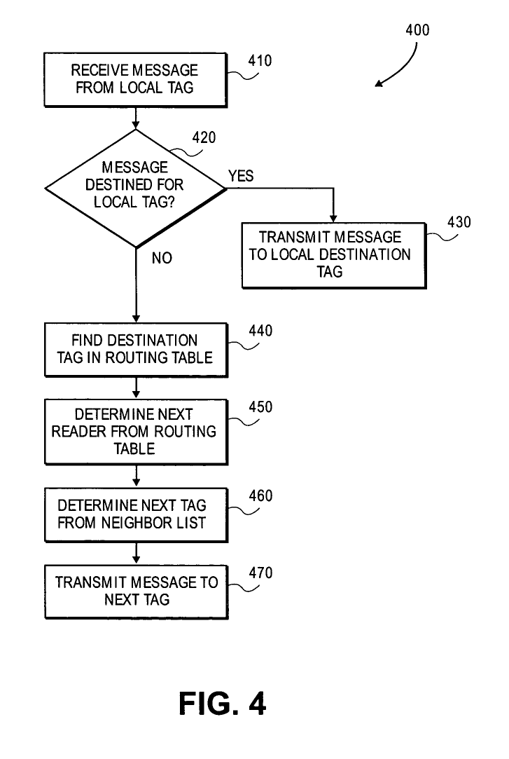

As implied by the previous descriptions, there may be multiple possible routing paths between any two given RFID tags, and some may be more direct, faster, or efficient than others. Any feasible technique may be used to select a preferred path. FIG. 4 shows a flow diagram of a particular method of determining where to forward a message, according to an embodiment of the invention. The method may be performed within an RFID reader, or by a processing device acting in cooperation with the RFID reader. In the illustrated embodiment of flow chart 400, at 410 a message may be received from a local RFID tag at 410. The message may be received in response to a poll transmitted by the RFID reader. The message may contain a destination address that indicates the intended eventual recipient of the message.

The destination address may be examined at 420 to determine if the destination is a local RFID tag. If it is, the RFID reader may transmit the message directly to that RFID tag at 430. If, however, the destination is an RFID tag that is not local, the RFID reader may examine, at 440, a routing table that is associated with the RFID tag that transmitted the message to the RFID reader at 410. It may use that routing table to determine at 450 which adjacent RFID reader to send the message to. If there are multiple such adjacent RFID readers, one may be selected by any feasible means, such as but not limited to using priority levels shown in FIG. 3B.

After selecting a ‘next’ RFID reader in this manner, a neighbor list (such as but not limited to the list shown in FIG. 3A) may be examined at 460 to determine which local RFID tags are also local to the selected next RFID reader. If there is more than one such shared RFID tag, a particular one may be selected in any feasible manner. The RFID reader may then transmit the message to the selected RFID tag at 470. The RFID tag may store the message in its transfer queue as described elsewhere, for subsequent forwarding to the previously-selected ‘next’ RFID reader.

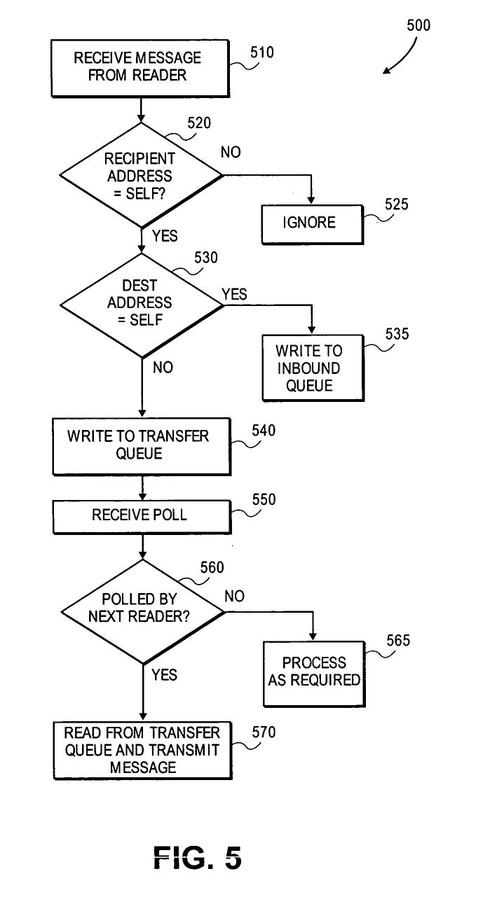

FIG. 5 shows a flow diagram of a method of handling a message within an RFID tag, according to an embodiment of the invention. In flow diagram 500, at 510 the RFID tag may receive a message from an RFID reader. If the message includes a recipient address specifying which of multiple RFID tags is intended to act upon the message, that address may be examined at 520. If the RFID tag is not the intended recipient, the message may be ignored and/or discarded at 525. If it is the intended recipient, processing may move to 530. In some embodiments no recipient address is used, in which case each RFID tag that receives the message may perform the indicated operations. This may cause some redundant message routing paths, a situation that may be subsequently sorted out and handled by the RFID readers or other devices with sufficient processing capability.

At 530 the destination address may be examined. If the RFID tag performing the examination is the one indicated by the destination address, then the message may be written into the inbound queue at 535, for use by whatever device is associated with this particular RFID tag. If the destination address is different, the message may be written into the transfer queue at 540, for subsequent delivery to another RFID reader.

At 550, the RFID tag may be polled by an RFID reader. If the ‘next reader’ selected in FIG. 4 is identified at 560 as the polling RFID reader, the message may be read from the transfer queue and transmitted at 570 in response to the poll. If the polling RFID reader is not the ‘next reader’, the response to the poll may be outside the scope of this description, and the poll may be responded to at 565 in whatever manner is appropriate. If the RFID tag has no means to tell whether the polling RFID reader is the previously identified next reader, then the polling RFID reader may be assumed to be the next reader, and the operation at 570 performed. Depending on how many RFID readers can communicate with this RFID tag, this action may result in redundant message paths, which may subsequently be sorted out and resolved by other devices.

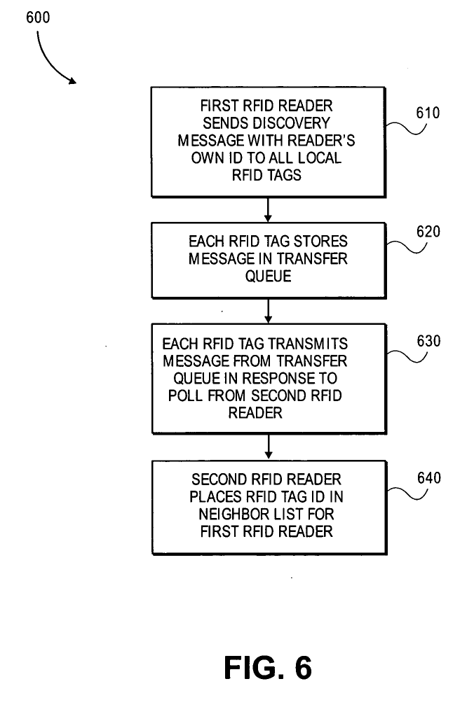

Before the aforementioned communications techniques may be used effectively, the RFID readers need to have correct information on the configuration of the network. In particular, the neighbor list and the routing tables need to be constructed and/or updated from time to time. FIG. 6 shows a flow diagram of a method of creating a neighbor list, according to an embodiment of the invention. In flow diagram 600, at 610 an RFID reader may send a ‘discovery’ message, identifying itself as the sender, to all local RFID tags. The list of local RFID tags may have been previously established, or may be newly constructed by sending an activation poll (or a series of such polls) and making a list of all RFID tags that respond. The discovery message may be sent in various ways, such as but not limited to: 1) sending individually addressed discovery messages to each local RFID tag, 2) sending a discovery message to a broadcast or multicast address that all the local RFID tags will recognize, and 3) sending an unaddressed discovery message that will be recognized by all local RFID tags.

At 620, each RFID tag that receives and recognizes the discovery message may store the discovery message in its transfer queue. At 630, each RFID tag that has placed the discovery message in its transfer queue may subsequently respond to a poll from an RFID reader by transmitting the discovery message to the polling RFID reader. The polling RFID reader may then, at 640, receive the discovery message from the polled RFID tag and store the ID of the originating RFID reader, along with the ID of the RFID tag that was just polled. This combination (originating RFID reader and shared RFID tag) may make up one entry in a neighbor list, such as that shown in FIG. 3A. If all the RFID readers perform these two processes multiple times (i.e., transmitting discovery messages, and receiving discovery messages from other RFID readers), each RFID reader may eventually construct a list of adjacent RFID readers and the RFID tags that it has in common with them.

In some embodiments, transmitting the contents of the transfer queue may empty those contents from the transfer queue, so that subsequent polls from other RFID readers would not result in the message being transmitted to those readers. In network configurations where multiple RFID readers can poll a given RFID tag, only the first reader to poll the tag would receive the discovery message. This may be overcome by using irregular communication schedules to: 1) send out new discovery messages from the same RFID reader, 2) poll RFID tags to get discovery messages, or 3) both. By relying on the relatively random nature of these communications, over time different RFID readers will be the first to poll a given RFID tag and eventually every RFID reader will be able to build a complete neighbor list. Repeating the process also may be helpful in updating the neighbor lists in networks that are reconfigurable due to various reasons, such as but not limited to having movable RFID tags and/or RFID readers. In some instances, the originating RFID reader may be the first one to poll the tag (especially when the tag is not shared with another RFID reader), and it would thereby receive its own discovery message, but it may simply discard any discovery message listing itself as the originator.

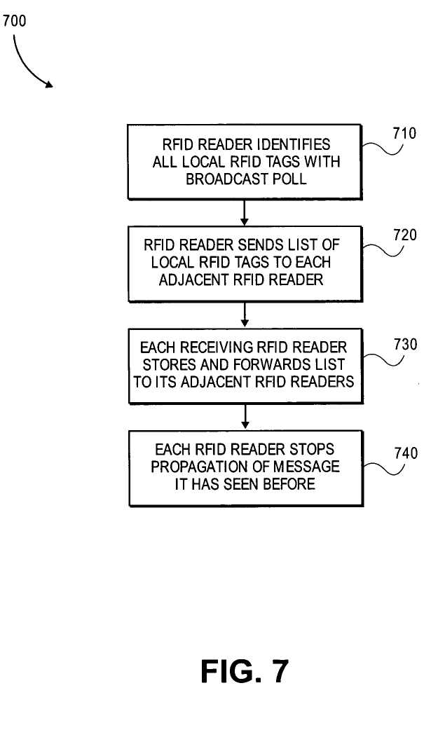

FIG. 7 shows a flow diagram of a method of creating a routing list, according to an embodiment of the invention. In the illustrated embodiment of flow diagram 700, at 710 an RFID reader may make a list of all the local RFID tags within its communications range by transmitting one or more broadcast polls (i.e., polls not addressed to any particular RFID tags), and recording the ID's of the RFID tags that respond. This list may then be delivered to any adjacent RFID readers at 720 via the RFID tags that the two readers have in common. A previously constructed neighbor list may be useful in this communication.

Each RFID reader that receives this list may place the list in a routing table associated with the originating RFID reader, and then forward the list at 730 to any adjacent RFID readers, which may record and forward the list in the same manner. Through this process, the list of local RFID tags for each RFID reader may eventually propagate to all RFID readers in the network. After every RFID reader in the network has propagated its own list of local RFID tags in this manner, every RFID reader may have constructed a correct routing list for all RFID readers in the network. To keep the propagation from going on forever, any RFID reader that receives a list it has seen before may discard the list at 740 rather than store and forward it.

The foregoing description is intended to be illustrative and not limiting. Variations will occur to those of skill in the art. Those variations are intended to be included in the various embodiments of the invention, which are limited only by the spirit and scope of the appended claims.

What is claimed is:

1. A method, comprising:
receiving a message to direct to a destination node in a network;
examining a table to determine which adjacent radio frequency identification (RFID) reader to send the message to;
examining a list to determine a local RFID tag that the adjacent RFID reader is able to communicate with;
transmitting the message to the local RFID tag.

2. The method of claim 1, wherein said examining a table comprises:
locating the destination node in the table; and
selected an adjacent RFID reader associated with the destination node in the table.

3. The method of claim 1, wherein said receiving comprises receiving a destination address identifying the destination node.

4. An article comprising
a machine-readable medium that provides instructions, which when executed by a computing platform, cause said computing platform to perform operations comprising:
receiving a message to direct to a destination node in a network;
examining a table to determine which adjacent radio frequency identification (RFID) reader to send the message to;
examining a list to determine a local RFID tag that the adjacent RFID reader is able to communicate with;
transmitting the message to the local RFID tag.

5. The article of claim 4, wherein said examining a table comprises:
locating the destination node in the table; and
selecting an adjacent RFID reader associated with the destination node in the table.

6. The article of claim 4, wherein said receiving comprises receiving a destination address identifying the destination node.

7. A method, comprising:
receiving a message from a first radio frequency identification (RFID) reader, the message comprising a destination address for the message;
writing the message to a first queue if the destination address is a particular address;
writing the message to a second queue if the destination address is not the particular address;
receiving a poll from a second RFID reader; and
transmitting the message in the second queue to the second RFID reader responsive to said receiving the poll.

8. The method of claim 7, wherein the first queue is an inbound queue and the second queue is a transfer queue.

9. The method of claim 7, wherein:
said receiving the message further comprises receiving the message with a recipient address; and
said writing the message to the second queue comprises writing the message to the second queue if the recipient address is a particular recipient address and not writing the message to either the first or second queue if the recipient address is not the particular recipient address.

10. The method of claim 7, wherein said receiving the poll comprises receiving an addressed poll.

11. An article comprising
a machine-readable medium that provides instructions, which when executed by a computing platform, cause said computing platform to perform operations comprising:
receiving a message from a first radio frequency identification (RFID) reader, the message comprising a destination address for the message;
writing the message to a first queue if the destination address is a particular address;
writing the message to a second queue if the destination address is not the particular address;
receiving a poll from a second RFID reader; and
transmitting the message in the second queue to the second RFID reader responsive to said receiving the poll.

12. The article of claim 11, wherein the first queue is an inbound queue and the second queue is a transfer queue.

13. The article of claim 11, wherein:
said receiving the message further comprises receiving the message with a recipient address; and
said writing the message to the second queue comprises writing the message to the second queue if the recipient address is a particular recipient address and not writing the message to either the first or second queue if the recipient address is not the particular recipient address.

14. The article of claim 11, wherein said receiving the poll comprises receiving an addressed poll.

15. A method, comprising:
receiving a message from a radio frequency identification (RFID) tag, the message identifying a first RFID reader that originated the message; and
placing identifiers for the first RFID reader and the RFID tag in a list.

16. The method of claim 15, wherein:
said receiving is performed in a second RFID reader; and
the list identifies the RFID tag as an RFID tag that is local to the first RFID reader and local to the second RFID reader.

17. The method of claim 15, wherein the list comprises a neighbor list.

18. An article comprising
a machine-readable medium that provides instructions, which when executed by a computing platform, cause said computing platform to perform operations comprising:
receiving a message from a radio frequency identification (RFID) tag, the message identifying a first RFID reader that originated the message; and
placing identifiers for the first RFID reader and the RFID tag in a list.

19. The article of claim 18, wherein:
said receiving is performed in a second RFID reader; and
the list identifies the RFID tag as an RFID tag that is local to the first RFID reader and local to the second RFID reader.

20. The article of claim 18, wherein the list comprises a neighbor list.

21. A method, comprising:
receiving a message from an RFID tag, the message containing a list of radio frequency identification (RFID) tags that are local to a particular RFID reader; and
storing the list in a table.

22. The method of claim 21, wherein the list originated with the particular RFID reader.

23. The method of claim 21, further comprising not storing the list if the list has been previously stored.

24. An article comprising
a machine-readable medium that provides instructions, which when executed by a computing platform, causing said computing platform to perform operations comprising:
receiving a message from an RFID tag, the message containing a list of radio frequency identification (RFID) tags that are local to a particular RFID reader; and
storing the list in a table.

25. The article of claim 24, wherein the list originated with the particular RFID reader.

26. The article of claim 24, further comprising not storing the list if the list has been previously stored.

27. An apparatus, adapted to:
contain a list of radio identification (RFID) readers, the list also identifying RFID tags that are local to each RFID reader on the list and also local to another particular RFID reader.

28. The apparatus of claim 27, wherein the apparatus is further adapted to use the list to select an RFID tag as a store-and-forward node to communicate between the particular RFID reader and another RFID reader in the list.

29. The apparatus of claim 28, wherein the apparatus is further adapted to use a table to select an adjacent RFID reader from RFID readers in the list, and to direct a message to the adjacent RFID reader through the selected RFID tag.

30. The apparatus of claim 28, wherein the apparatus comprises the particular RFID reader.

31. The apparatus of claim 30, wherein the particular RFID reader comprises an antenna.
